(19) United States
(12) Patent Application Publication
(10) Pub. No.: US 2012/0072612 A1
(43) Pub. Date: Mar. 22, 2012

(54) Method and an Arrangement of Identifying Traffic Flows in a Communication Network

(76) Inventors: Christofer Flinta, Stockholm (SE); Jan-Erik Mängs, Solna (SE); Bob Melander, Sigtuna (SE)

(21) Appl. No.: 13/141,501

(22) PCT Filed: Dec. 23, 2008
(86) PCT No.: PCT/SE08/51557

§ 371 Date: Dec. 9, 2011

(51) Int. Cl. G06F 15/16

(52) U.S. Cl. 709/235

(57) ABSTRACT

A method of identifying traffic flows is provided in a traffic generating node, where each traffic flow is being associated with an application process running on the traffic generating node. The method is configured to perform a mapping operation, such that an application process is being linked to a signature that uniquely identifies a traffic flow and an associated socket, and such that the obtained linked information is maintained in a list. The mapping operation is configured to be executed in response to recognising a change to a socket associated with the application process at the traffic generating node. Based on accumulated mapping information, one or more processing element located at the traffic generating node, or at another node, may classify and/or control traffic flows associated with any of the application processes of the traffic generating node.

### TECHNICAL FIELD

The present invention relates to a method for enabling identification of traffic flows in a communications network, and to network nodes that are configured to execute such a method.

### BACKGROUND

Today IP traffic is used for a large amount of information distribution. In order to enable for network traffic flows generated by some application that is running on a node shall to be serviced by the network in a controlled way, e.g. such that they can be forwarded by the network in a controlled way, the network nodes involved in the transport has to be able to identify the traffic flows originated by the application. Such a network node may be equivalent to the node that hosts the respective application, or may be a separate, intermediate node, such as e.g. a home gateway, an access node, a switch, a router, or a Broadband remote Access Server (BRAS), that is associated with any type of processing, or controlling of traffic flows.

The US patent application US 2006 0251234 refers to a method for enabling an end-user to managing bandwidth in a communication network. The end-user is provided with a turbo button service which enables the user to request for additional bandwidth from the network provider upon demand.

An invocation of the request results in a change in a default bandwidth associated with the user's access connection, thereby enabling the user to, to at least some extent, be able to control the use of bandwidth, depending on the application used and the present network load. The method of US 2006 0251234 is however not adapted to identify different traffic flows that are associated with the network node.

Identification of traffic flows can be particularly challenging in situations, such as when an application is generating traffic flows with random port numbers. In such a scenario identification of a traffic flow at a forwarding node will typically require the forwarding node to look into the payload of each packet of the traffic flow. This mechanism is often referred to as deep packet inspection. However, for nodes with limited processing power, such as e.g. home gateways, that are typically provided with low-end processors in order to keep prices low, conventional traffic flow identification mechanisms that require deep packet inspection are often too demanding when it comes to required processing capacity to be feasible.

Efficient handling of traffic flows in home gateways and access nodes is usually of particularly large interest since the last mile link of a network is often a bottleneck in terms of capacity. It is also most likely that this is a fact that will probably not change for a long time to come.

To exemplify the described problem, one can imagine the common scenario that one person located in a home is engaged in downloading of large files, while relying on extensive use of the commonly used Bit Torrent protocol.

Such a downloading may comprise a large number of simultaneous Bit Torrent TCP connections, each of which will have different port numbers, that may require a large fraction of the available access link bandwidth. One typical effect from such a scenario may be that another person in the home will experience that web surfing is turning very slow, or that a video call is being severely disturbed.

Hence, while the access link could benefit from localized Quality of Service (QoS) mechanisms, those mechanisms may in practice be inapplicable when utilizing services provided via a communication network, because the node on which the application is running, as well as other nodes associated with the network, such as e.g. a home gateway and/or access node, that are participating in the forwarding of the traffic flows, are unable to maintain a record for enabling a fast and easy identification of the respective traffic flows.

### SUMMARY

It is an object of the present invention to address at least some of the problems mentioned above. More specifically the present invention relates to a method enabling identification of traffic flows in a communications network, and to network nodes that are configured to execute such a method.

According to one aspect, a method of identifying traffic flows on a node, referred to as a traffic generating node, is provided. According to the method, each traffic flow is associated with an application process that is running on the traffic generating node. The traffic flow identification method is configured to perform a mapping operation, which is configured such that an application process is linked to a signature that uniquely identifies a traffic flow and an associated socket, and such that the linked information is maintained in a list. The method is also configured such that the mapping operation will be executed in response to recognising a change to a socket, associated with the respective application process.

The traffic flow signature is based on information associated with a respective socket, and this information may comprise an indication of the protocol used by the respective application, the source IP address, the source port and the destination IP address and the destination port associated with the respective socket.

According to one embodiment, the recognising step may be achieved by actively monitoring one or more application processes for socket related changes, while according to another embodiment, the recognising step may instead be achieved by receiving a notification of a socket related change from an application process.

Traffic flow classifications may be executed on the basis of accumulated content managed by the suggested linking process, in combination with at least one predefined classification rule.

The accumulated content may be used for controlling traffic flows on the basis of accumulated classification content, possibly in combination with at least one predefined controlling rule. Such a controlling step may be executed by one or more processing elements, located on the traffic generating node, or by one or more processing elements located on another network node.

In a method configured for executing the latter case, a notification comprising the content of a respective generated or updated mapping entry of the list maintained at the traffic generating node is generated, and forwarded to at least one server, thereby enabling the server to create and maintain a copy of the list.

According to another aspect, a method may be provided at a server, that comprises at least one processing element, wherein a classification of one or more traffic flows may be executed on the basis of accumulated content of the list and at least one predefined rule.

According to yet another aspect, another method may be provided at a server, that comprises at least one processing element, wherein controlling of one or more traffic flows may be executed on the basis of at least one predefined rule and accumulated content of the list maintained and updated in a traffic generating node.

The claimed invention also relates to a traffic generating node that is configured to execute a method according to any of the suggested embodiments.

The suggested method provides a simplified mechanism for identifying traffic flows associated with application processes. By applying the suggested mechanism in a traffic generating node a reliable and user friendly tool for classifying and/or controlling traffic flows will also be provided.

Further features of the suggested method, and nodes configured to execute such a method, and associated benefits will be explained in the detailed description below.

### BRIEF DESCRIPTION OF THE DRAWINGS

The present invention will now be described in more detail by way of non-limiting examples and with reference to the accompanying drawings, in which:

FIG. 1 is a simplified overview of a system, comprising a client and a server, that are configured for maintaining and managing traffic flow identification information.

FIG. 2a is a flow chart, illustrating a signature mapping process configured to enable traffic flow identification, according to one embodiment.

FIG. 2b is a flow chart, illustrating a signature mapping process configured to enable traffic flow identification, according to another embodiment.

FIG. 3 is a flow chart, is a general illustration of a traffic flow identification process.

FIG. 4 is another flow chart, illustrating a process for controlling traffic flows on a server on the basis of traffic flow identification information provided from a traffic generating node.

FIG. 5 is an exemplified architecture of a traffic generating node that is configured to update a server with traffic flow identification information at a server.

FIG. 6 is an exemplified architecture of a traffic controller adapted to store and use accumulated traffic flow identification information, provided from a traffic generating node.

FIG. 7 is an exemplified architecture of a traffic generating node that is configured to manage a traffic flow identification process and to use this information for classification and/or controlling purposes.

FIG. 8 is an exemplified architecture of a signature engine adapted to manage traffic flow classification, according to any of the embodiments described with reference to FIG. 5 or 7.

### DETAILED DESCRIPTION

Briefly described, a desire for enabling classification, as well as for enabling controlling of different traffic flows, both on a node on which one or more applications are running, as well as on a server, which typically may be limited to having a low-end processing capacity, which is handling traffic flows, raises a demand for an improved traffic flow identification mechanism that can be run on a traffic generating node and that can provide relevant identification information both to processing elements of the traffic generating node itself, as well as to processing elements of other network nodes, that may benefit from being able to use such updated information for traffic flow controlling purposes. Different aspects of such a mechanism will be described in further detail below.

The suggested traffic flow identification mechanism is based on the general principle that a host, on which one or more application processes are running, is adapted to determine, and keep track of, which sockets, or equivalently, which logical network exchange points, that are bound to which application.

A socket, or a logical network exchange point, is a communication end-point that is unique to a specific machine communication on an Internet Protocol-based network. Operating systems combine sockets with a running process or processes, which use the sockets when communicating with other entities over the network, and a protocol, such as e.g. TCP or UDP, with which the processes communicate to a remote host. Information associated with sockets can therefore be used for the purpose of uniquely linking an application process to one or more traffic flows, associated with the application.

If applying such a mechanism, a host may therefore be able to uniquely identify the traffic flows that a respective application is generating on the basis of socket information, such as e.g. a relevant IP address and a port number, that are coupled to the respective application. On the basis of this information, also intermediate communications network nodes, typically nodes with limited processing power, may be able to maintain updated traffic flow identification information, e.g. for the purpose of controlling traffic flows in an efficient manner, if this type of information is repeatedly forwarded to, and updated by these nodes.

Throughout this document, the node hosting the proposed traffic flow classification mechanism will be referred to as a traffic generating node. It is, however, to be understood that typically this node is not restricted to a node that can only transmit traffic to the network nodes, but that it is adapted both to send and to receive traffic that is associated with an application of the traffic generating node.

In order for a processing element of a distributed node, to which this information has been delivered, or a processing element of the node itself, to be able to use information associated with the respective traffic flows, an application to traffic flow mapping will be performed each time an application has made any change to a socket, which, as a consequence, will have an impact on at least one of the present traffic flows.

By repeatedly updating changes associated with any of the applications, and by assuring that a respective processing element will have access to updated mapping information in response to such a change, the processing element, which may be an element that is integrated with the traffic generating node, or an element of a distributed, stand-alone entity, such as e.g. a home gateway or a residential gateway, a access node, a switch, a router or a BRAS, will be able to control each traffic flow originating from, or being sent to, the traffic generating node in a much more efficient and reliable way than what is possible with alternative conventional solutions.

A schematic overview of a system that is adapted to manage and, to provide such mapping information to a distributed processing element is shown in FIG. 1, where a terminal 100 is used by an end-user for running one or more applications. The traffic generating node 100 comprises a Client 101 which is adapted to manage the applications and the associated traffic flows, and a network node 102, in this case a stand-alone network node, comprising a Server 103, that is adapted to update and maintain traffic flow identification information, that is provided to the server 103 via repeatedly forwarded updating messages, or notifications 104, thereby enabling one or more processing elements of network node 102 to classify and/or to control traffic flows on the basis of this updated information.

According to another, alternative embodiment, one or more processing elements may instead be a part of the traffic generating node and, thus, the suggested traffic flow identification mechanism is both executed and used directly on the traffic generating node 100, where the result of such a traffic flow identification procedure may be used for classification purposes or for controlling purposes for a variety of different applications, such as e.g. in a firewall application, which is adapted to control/filter traffic flows, or for executing rate control of the different traffic flows.

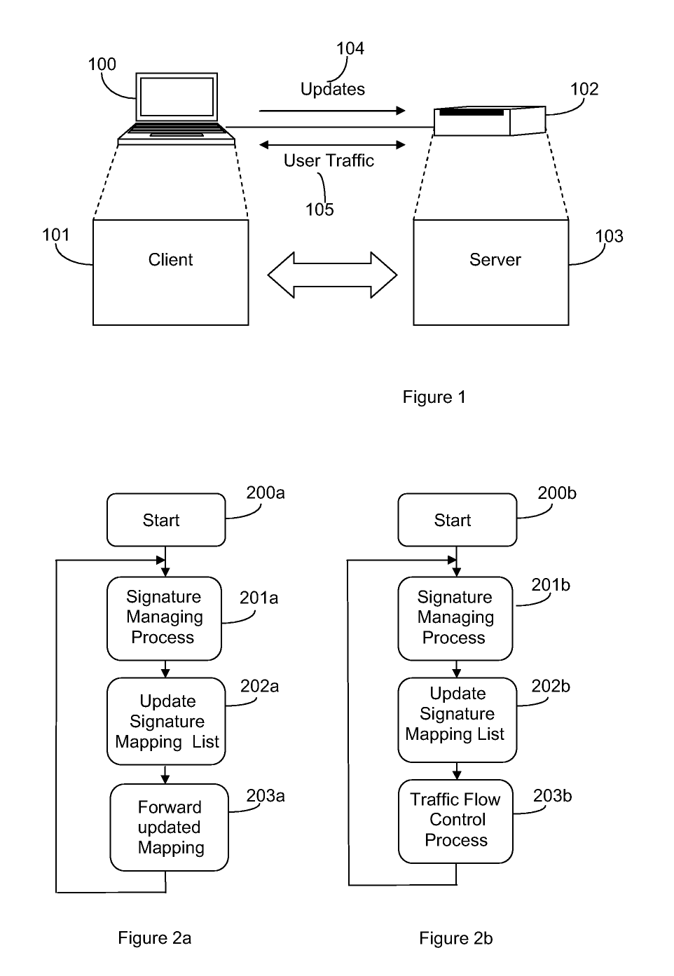

More specifically, a method for executing such a traffic flow identification mechanism presented above at a traffic generating node may be described according to any of the simplified flow charts, illustrated in FIGS. 2a and 2b, where FIG. 2a schematically illustrates an identification method for managing traffic flow identification information in one node, which may be used at another node, while FIG. 2b is a flow chart, exemplifying a method which manages identification information that can be used on the same node.

In a first step 200a of FIG. 2a the method is started at a client of a traffic generating node. As already mentioned above, the described mechanism relies on a process for managing an application to traffic flow mapping, which in this context is referred to as a signature mapping process. Such a process is executed as indicated with a step 201a.

Each time a signature mapping needs to be executed or updated, e.g. each time an application has been started or closed on the traffic generating node, an updating procedure will be executed, wherein a mapping is either executed and inserted into a list, from hereinafter referred to as a signature mapping list, or, if a mapping has already been stored for a respective application, the respective entry in the signature mapping list is updated accordingly. This is indicated with another step 202a.

The updating procedure of FIG. 2a comprises the steps of generating and forwarding a notification, comprising updated information, associated with the respective change, to one or more servers, each of which comprises at least one processing element that may use the respective updated information, for traffic flow classification purposes. Such a procedure is indicated with a final step 203a. Which servers to provide the information to may be given, e.g., by a pre-configured list of nodes.

Alternatively, the information is updated directly at the traffic generating node, where the updated information can be used for traffic flow controlling purposes. Such an alternative embodiment is illustrated in FIG. 2b, where steps 200b-202b corresponds to steps 200a-202a, respectively. Once traffic flow identification information has been updated in a signature mapping list, as indicated with step 202b, however, the accumulated information may be used for controlling traffic flows, as indicated with a final step 203b of FIG. 2b.

Both embodiments are typically configured as repeating processes that are iteratively repeated as long as traffic flow identification information is desired.

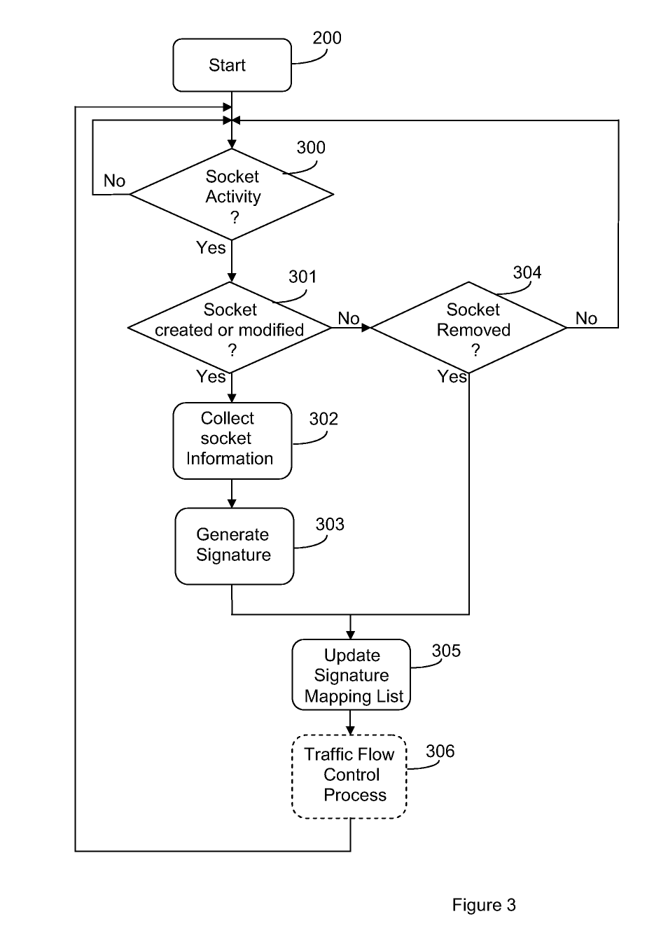

The signature managing methods illustrated with reference to FIGS. 2a and 2b, can be described in further detail with reference to the flow chart of FIG. 3, where the signature managing processes 201a, 201b, respectively, of FIGS. 2a and 2b is represented by steps 300-304 in FIG. 3.

According to FIG. 3 it is first determined whether any activity related to any socket that is associated with an application of a traffic generating node has occurred, as indicated with a step 300. If this is the case, it is then determined whether a socket has been created or modified. This is done in a subsequent step 301. If it is determined that a socket has been created or modified, information related to that socket, which is required for generating a signature, is collected, as indicated with another step 302, and in a subsequent step 303, a signature associated with that socket is generated.

If, however, no socket has been created, it is determined whether a socket has been removed, e.g. if an application has been closed. This is illustrated with a step 304. If either a socket has been created, modified or removed, the signature mapping list is then updated in a next step 305, as indicated also in FIGS. 2a and 2b, with steps 202a and 202b, respectively.

A traffic flow signature may in its simplest form be defined as the tuple:
<Protocol; Source IP Address; Source Port; Destination Address; Destination Port>

where the protocol indicates the protocol used by the application, the source IP address and source port uniquely links a traffic flow to a source entity, while the destination address and destination port is a link to the destination node.

The information listed above may then be used to uniquely identify a respective traffic flow as being associated with a certain application.

Alternatively, a signature may be configured according to one or more pre-defined rules, such that a traffic flow being associated with a signature comprising certain information will be handled in a predefined way. In such a case such predefined rules may e.g. be stored in a dedicated list, e.g. a rules list (not shown).

In a final step 306, which corresponds to step 203a and 203b, the accumulated traffic flow identification information that is accessible from the signature mapping list may be used for classification and/or controlling purposes, before the process is repeated, starting at step 200.

If the method described with reference to FIG. 2b is applied, one procedure for maintaining and updating traffic flow identification information, and another process for using this information for some kind of controlling purpose, will be required at the server.

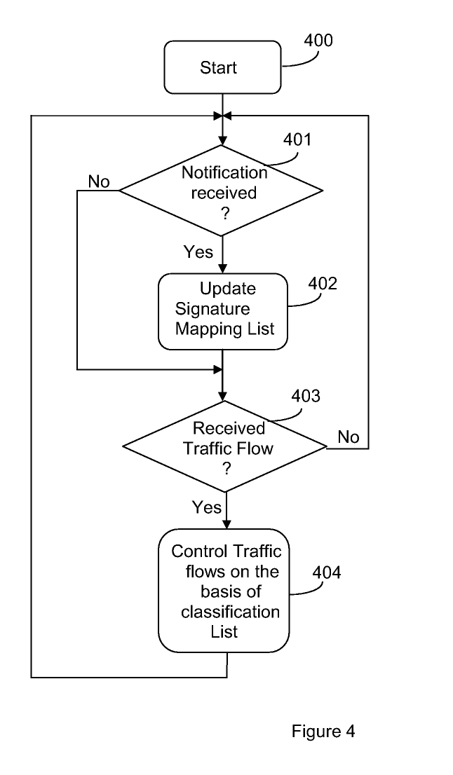

A flow chart, describing the steps of a method for executing these two processes will therefore now be described with reference to FIG. 4.

FIG. 4 refers to a repeating process for maintaining traffic flow identification information, in a signature mapping list of the server.

As the server is being repeatedly updated with traffic flow classification information provided from a traffic generating node, the content of such a list can be used for traffic flow controlling purposes, where traffic flows associated with application processes that are run on the traffic generating node can be identified and controlled. In the context referred to in this document, the described traffic flow control may be managed by a dedicated unit, which hereinafter will be referred to as a Traffic Controller, located at the server.

In a first step 400 of FIG. 4, a classification method is started. In a next step 401 it is determined whether a notification has been received from a traffic generating node. If it is determined that a notification has been received, the content of this notification is updated in the signature mapping list, as indicated in another step 402.

The traffic controller will be able to control the respective traffic flows on the basis of the information retrieved via the notifications, and, thus, in a next step 403, where traffic flow control process is initiated, it is determined whether a traffic flow originating from, or sent to, the traffic generating node has been received by the server. If this is the case, the traffic flow can be controlled on the basis of the information retrieved from the classification list, as indicated with a final step 404. The process is then repeated, starting at step 401.

The controlling step may typically comprise a procedure where a traffic flow, once it has been identified from the traffic flow identification information, is controlled on the basis of rules, that are typically pre-configured and stored at the traffic controller of the server.

According to such rules, traffic flows associated with certain ports may be blocked, while other traffic flows are allowed to be forwarded from the node. Other rules may specify more complex conditions for when to block and when to forward traffic flows, and for how different traffic flows are to be handled, e.g. in situation when the respective node is heavily loaded.

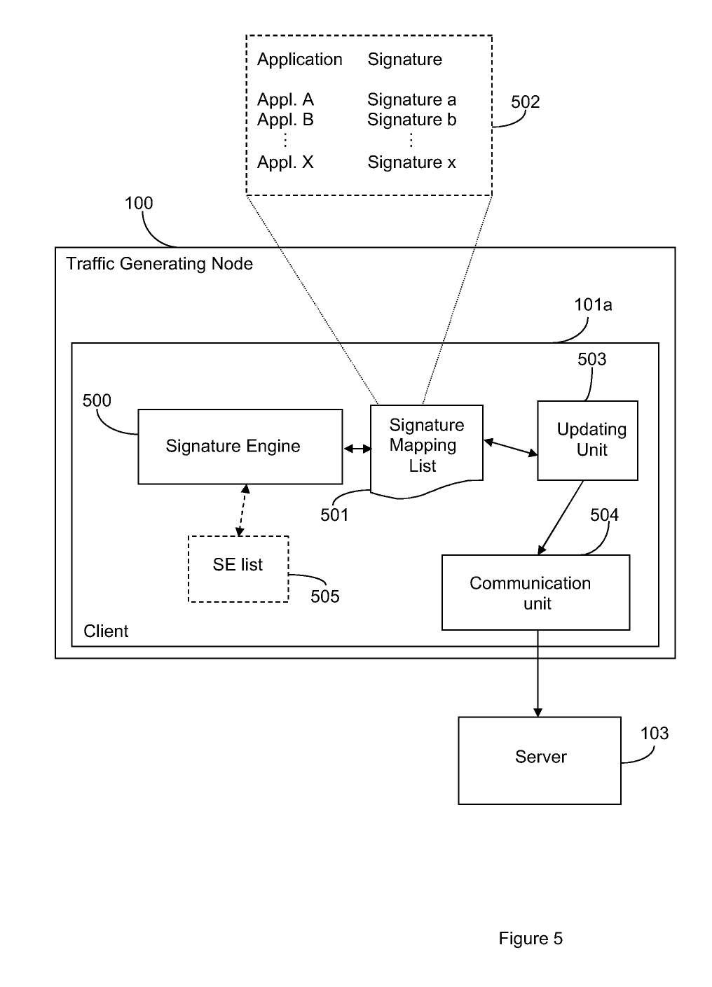

A simplified block scheme of a traffic generating node 100, according to the second embodiment described above, will now be described with reference to FIG. 5.

According to this embodiment, a client 101a, comprises a unit, referred to as a Signature Engine (SE) 500, which is configured to execute and manage the signature managing process mentioned above. The signature managing process is responsible for maintaining an application to traffic flow mapping, i.e. to uniquely appoint a signature to a traffic flow, associated with an application process, once it has been determined that the application process has started.

The signature engine 500 is also configured to update already existing mapping information, such that an entry associated with a respective application will be removed when an application, or any of the sockets associated to it, has been closed. The application to traffic flow mapping is maintained in a list, here referred to as a Signature Mapping List 501, which may be configured e.g. as exemplified by table 502. In this list, a number of applications A to X, each of which may be identified with a respective process identity (process ID), can also be identified with a signature, such that application A is appointed signature a and application B is appointed signature b, respectively.

As indicated with the signature that was exemplified above, the signature will contain information from which one or more sockets, and thus, associated traffic flows can be identified.

Alternatively, the content of a signature may be conditional, according to pre-configured rules, where e.g. traffic flows associate with a signature comprising classification information will be processed in a certain way. Such rules may be stored in a list, here referred to as a Signature Engine (SE) list 505.

A change associated with an application process that has been recognised by the signature engine 500 triggers an updating unit 503 to execute an updating procedure, wherein a notification is generated and forwarded to one or more network nodes, in this case to server 103.

In its simplest form, such a notification may comprise an identifier of the respective application process, such as e.g. a process identifier (PID), together with the signature associated with the respective process, as indicated above, but the signature may be even more specified, comprise additional information.

The notification is forwarded to one or more servers via a communication unit 504, where the content is stored in a storage means together with traffic flow identification information that has been updated earlier, i.e. a copy of the signature mapping list maintained and stored at the traffic generating node, will be maintained also at the one or more servers that are configured to be updated by the traffic generating node. The accumulated traffic flow identification information may be used for controlling traffic flows associated with the applications that are run on the traffic generating node 100, in parallel to the managing the traffic flow identification process, and, thus, changes to sockets that may occur for maintaining and closing the respective traffic flows will be handled in a flexible and simple way, without requiring any interaction from the end-user, other than some preconfigured settings.

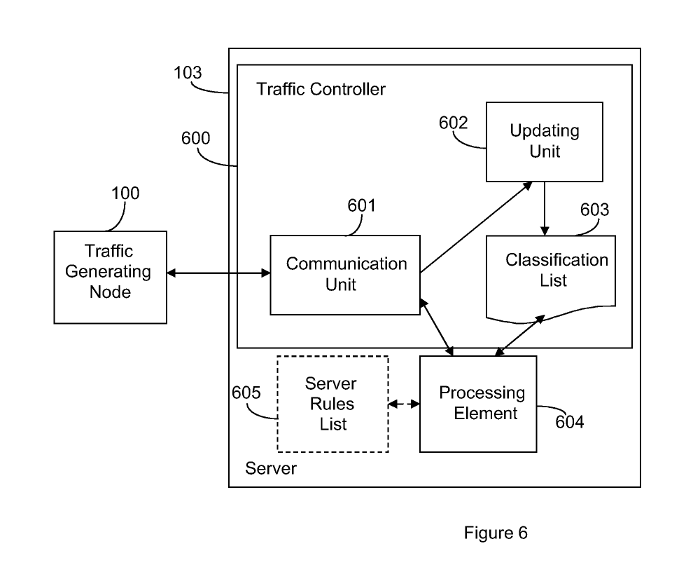

A network node comprising a server 103, which has been adapted to receive traffic flow related notifications from a traffic generating node 100, such as the one mentioned above, may, according to one embodiment, be configured according to the exemplified architecture of FIG. 6.

Server 103 of FIG. 6 comprises an entity, here referred to as a Traffic Controller 600, which is adapted to maintain and manage updated mapping/traffic flow identification information obtained from a traffic generating node 100. The server 103 receives notifications via a communication unit 601, and an updating unit 602 is configured to update a list, here referred to as a classification list 603, with the mapping content obtained from the notifications, each time the communication unit 601 indicates a reception of such a notification. Under normal circumstances classification list 603 will be a copy of the signature mapping list of traffic generating node 100.

On the basis of the accumulated content of the classification list 603, one or more processing elements 604, that has access to the content of the classification list will be able to control traffic flows that are handled by the server 103.

In a typical configuration, the processing element may have access to pre-configured rules, which specify certain conditions for how to control a respective traffic flow. Such rules may e.g. be stored in a list, here referred to as a Server Rules List 605. Such a list may e.g. map a processing rule to one or more alternatives of a specific signature field.

According to the first embodiment described above, the traffic generating node 100 may instead comprise a client that is instead configured to control traffic flows at the very same node as where the traffic flow identification information is being mapped, i.e. instead of generating and transmitting a notification to one or more servers, one or more processing elements of a traffic generating node may instead access the traffic flow identification/mapping information directly from a signature mapping list, and use the retrieved information for any appropriate processing.

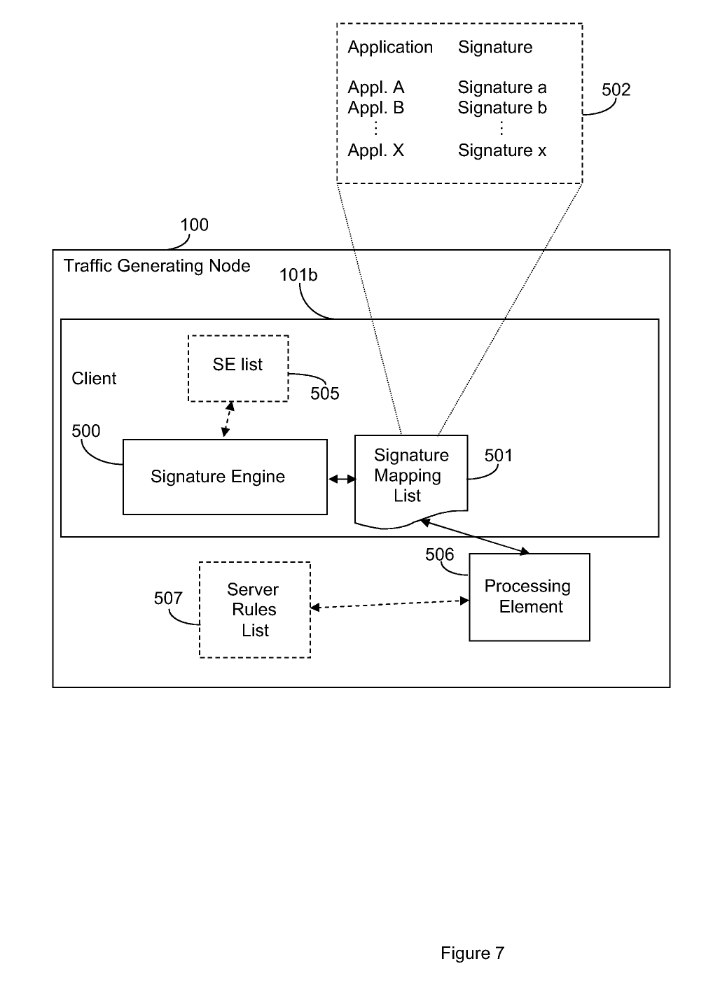

Such a configuration, according to one exemplified embodiment, will now be described with reference to FIG. 7. According to this alternative embodiment, a client 101b, comprising a signature engine 500, is adapted to manage a Signature Mapping List 501 in the same manner as was the case for client 101a described above with reference to FIG. 5. Instead of generating a notification, however, client 101b is connected to one or more processing elements, here represented by processing element 506, that may be configured to control traffic flows on the basis of content of the signature mapping list 501, e.g. for reducing BitTorrent traffic. Typically, the processing element 505 executes the controlling on the basis also of rules accessed from a server rules list 507, which may correspond to the server rules list 605 in FIG. 6. Accordingly, the client 101b may comprise also an SE list 505.

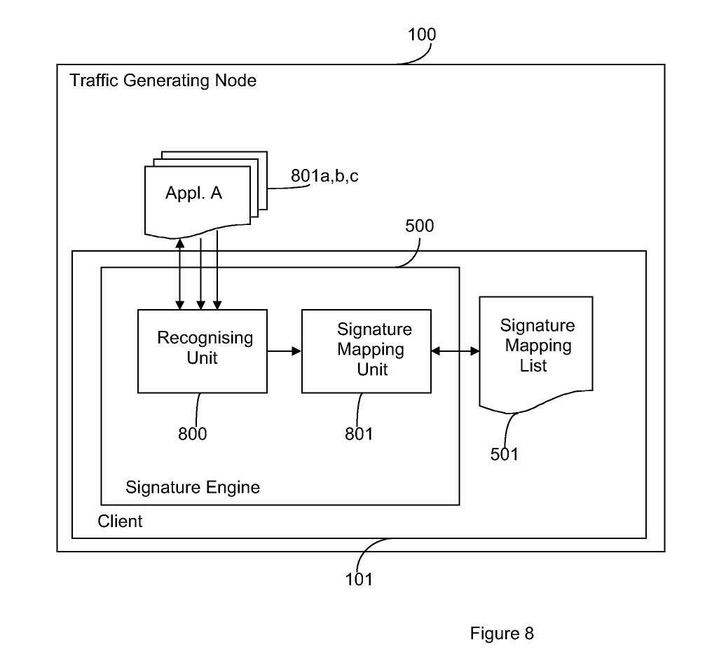

In order to further clarify the functionality of a signature engine 500 mentioned above, such an entity, according to one exemplary embodiment, will now be described in further detail with reference to FIG. 8.

As already mentioned above, the Signature Engine 500 has a purpose of updating and storing traffic flow related information, which in this context refers to changes made to sockets created or removed by the applications running on the traffic flow generating node 100.

The signature engine 500 therefore comprises a unit, referred to as a recognising unit 800 that is configured to recognise whenever a socket activity has occurred, and, thus, the signature mapping list 501 needs to be updated. More specifically, the recognising unit 800 is adapted to keep track of when an application 801a,b,c, available at the traffic generating node 100 has started and when an application has closed, respectively.

The recognising unit 800 may, according to one embodiment, be configured so that it is notified of a changed state of an application process 801a,b,c by the respective application process.

According to another embodiment, the recognising unit 800 may instead be configured to actively monitor applications of the traffic generating node for a change of state of an application process, and thus, of a change to a socket. Any of the two alternative recognition procedures may be implemented by way of using any conventional recognition, or monitoring functionality, respectively.

Once it has been determined that an application has started, the recognising unit 800 is configured to collect relevant information about the one or more sockets, associated with that application. On the basis of the socket related information collected by the recognising unit 800, a signature mapping unit 801 is then configured to generate a signature which, when later used by a processing element will enable a linking between the respective application process and the sockets, associated with the application process, and, thus, with a traffic flow for which a respective socket has been dedicated. If any conditional rules are to be applied for the signature engine 500, such pre-configured rules may be stored e.g. in an SE list (not shown) in accordance with what has already been described above.

The application to signature mapping is then stored in a signature mapping list 501, which at any time will comprise a relevant link between an active application process and an associated signature.

When the recognising unit 800 recognises that a running application process has been closed, it will instead instruct the signature mapping unit 801 to update the signature mapping list 501, by removing the respective entry from the list.

As indicated above, the information stored in the signature mapping list 501 may then either be forwarded to one or more other nodes for storage in a corresponding signature mapping list and use, or be used directly by one or more processing elements at the traffic generating node.

Throughout this document, the terms used for expressing functional devices, entities or nodes, such as e.g. “traffic generating node”, “mapping manager”, “signature engine” and “traffic controller” “priority mapping unit”, as well as various units of the described devices, entities or nodes, such as e.g. “updating unit”, “updating unit”, “signature mapping unit” and “priority mapping unit” should be interpreted and understood in its broadest sense as representing any type of devices, entities, nodes or units which have been adapted to process and/or handle correlation data, according to the general principles presented in this document.

In addition, while the described method and nodes have been described with reference to specific exemplary embodiments, the description is generally only intended to illustrate the inventive concept and should not be taken as limiting the scope of the described concept, which is defined by the appended claims.

### Abbreviation List

BRAS Broadband remote Access Server

MM Mapping Manager

PID Process Identifier

SE Signature Engine

1-25. (canceled)

26. A method of identifying traffic flows in a traffic generating node, each traffic flow being associated with a respective application process running on said traffic generating node, said method comprising:
recognizing a change to a socket associated with an application process; and
performing a mapping operation with respect to that application process responsive to recognizing said change, wherein performing said mapping operation comprises linking the application process to a signature that uniquely identifies a traffic flow and an associated socket, and maintaining information regarding said linking in a list.

27. The method according to claim 26, wherein said signature is based on information associated with said socket.

28. The method according to claim 27, wherein said information comprises an indication of a protocol used by the respective application process, a source Internet Protocol (IP) address, a source port, a destination IP address, and a destination port associated with said socket.

29. The method according to claim 27, wherein recognizing a change to a socket associated with an application process comprises recognizing that a socket has been created by the application process, and wherein performing said mapping operation further comprises generating said signature.

30. The method according to claim 27, wherein recognizing a change to a socket associated with an application process comprises recognizing that a socket has been removed by the application process, and wherein performing said mapping operation further comprises removing a respective entry of said list.

31. The method according to claim 26, wherein said recognizing comprises monitoring said application process for socket related changes.

32. The method according to claim 26, wherein said recognizing comprises receiving a notification of a socket related change from said application process.

33. The method according to claim 26, further comprising classifying at least one of said one or more traffic flows on the basis of accumulated content of said list and at least one predefined classification rule.

34. The method according to claim 33, wherein said classifying is executed by at least one processing element of said traffic generating node.

35. The method according to claim 26, further comprising controlling at least one of said one or more traffic flows on the basis of accumulated content of said list and at least one predefined rule.

36. The method according to claim 35, wherein said controlling is executed by at least one processing element of said traffic generating node.

37. The method according to claim 26, further comprising, each time a mapping operation has been performed:
generating a notification comprising the content of a mapping entry created or updated in said list by way of said mapping operation, and
forwarding said notification to at least one server, thereby enabling said server to create and maintain a copy of said list.

38. A method implemented by a server for classifying traffic flows transmitted to or received from a traffic generating node, wherein the server comprises at least one processing element, wherein the method comprises:
maintaining a copy of a list created by the traffic generating node, wherein the list contains accumulated content regarding linking of each of one or more application processes running on the traffic generating node to a respective signature that uniquely identifies a traffic flow and an associated socket, wherein said maintaining comprises receiving one or more notifications from the traffic generating node comprising the content of one or more mapping entries created or updated in said list by the traffic generating node; and
classifying traffic flows on the basis of at least one predefined rule and the accumulated content of said list .

39. A method implemented by a server for controlling traffic flows transmitted to or received from a traffic generating node, wherein the server comprises at least one processing element, wherein the method comprises:
maintaining a copy of a list created by the traffic generating node, wherein the list contains accumulated content regarding linking of each of one or more application processes running on the traffic generating node to a respective signature that uniquely identifies a traffic flow and an associated socket, wherein said maintaining comprises receiving one or more notifications from the traffic generating node comprising the content of one or more mapping entries created or updated in said list by the traffic generating node; and
controlling traffic flows on the basis of at least one predefined rule and the accumulated content of said list .

40. A traffic generating node comprising a client for identifying traffic flows, each traffic flow being associated with a respective application process running on said traffic generating node, said client comprising a signature engine configured to:
recognize a change to a socket associated with an application process; and
perform a mapping operation with respect to that application process responsive to recognizing said change, wherein performing said mapping operation comprises linking the application process to a signature that uniquely identifies a traffic flow and an associated socket, and maintaining information regarding said linking in a list.

41. The traffic generating node according to claim 40, wherein said signature engine is configured to generate said signature to be based on information associated with said socket.

42. The traffic generating node according to claim 41, wherein said signature engine is configured to recognize a change to a socket associated with an application process by recognizing that a socket has been created by the application process, and to perform said mapping operation by generating said signature.

43. The traffic generating node according to claim 42, wherein said signature engine is configured to recognize a change to a socket associated with an application process by recognizing that a socket has been removed by the application process, and to perform said mapping operation by removing a respective entry of said list.

44. The traffic generating node according to claim 40, wherein said signature engine is configured to recognize a change to a socket by monitoring said application process for socket related changes.

45. The traffic generating node according to claim 40, wherein said signature engine is configured to recognize a change to a socket in response to receiving a notification of a socket related change from said application process.

46. The traffic generating node according to claim 40, further comprising a processing element that is configured to classify at least one traffic flow on the basis of accumulated content of said list and at least one predefined classification rule.

47. The traffic generating node according to claim 40, further comprising a processing element that is configured to control at least one of said one or more traffic flows on the basis of accumulated content of said list and at least one predefined control rule.

48. The traffic generating node according to claim 40, wherein said client further comprises an updating unit that is configured, each time a mapping operation has been performed, to:
generate a notification comprising the content of a mapping entry created or updated in said list by way of said mapping operation; and
forward said notification to at least one server via a communication unit, thereby enabling said server to create and maintain a copy of said list.

49. A server comprising at least one processing element that is configured to classify traffic flows transmitted to or received from a traffic generating node, wherein the processing element is configured to:
maintain a copy of a list created by the traffic generating node, wherein the list contains accumulated content regarding linking of each of one or more application processes running on the traffic generating node to a respective signature that uniquely identifies a traffic flow and an associated socket, wherein said maintaining comprises receiving one or more notifications from the traffic generating node comprising the content of one or more mapping entries created or updated in said list by the traffic generating node; and
classify traffic flows on the basis of at least one predefined classification rule and the accumulated content of said list.

50. The server according to claim 49, further comprising a traffic controller that is configured to create and maintain said copy of said list, and a communication unit for receiving said one or more notifications.

51. A server comprising at least one processing element that is configured to control traffic flows transmitted to or received from a traffic generating node, wherein the processing element is configured to:
maintain a copy of a list created by the traffic generating node, wherein the list contains accumulated content regarding linking of each of one or more application processes running on the traffic generating node to a respective signature that uniquely identifies a traffic flow and an associated socket, wherein said maintaining comprises receiving one or more notifications from the traffic generating node comprising the content of one or more mapping entries created or updated in said list by the traffic generating node; and
control traffic flows on the basis of at least one predefined classification rule and the accumulated content of said list.

52. The server according to claim 51, further comprising a traffic controller that is configured to create and maintain said copy of said list, and a communication unit for receiving said one or more notifications.
